(19) United States
(12) Patent Application Publication
(10) Pub. No.: US 2024/0293874 A1
(43) Pub. Date: Sep. 5, 2024

(54) DRAIN ASSEMBLY REMOVAL GUIDE AND METHOD THEREOF

(71) Applicants: Dale Edwin Hill, New Philadelphia, OH (US); Terry Hill, Canton, OH (US)

(72) Inventors: Dale Edwin Hill, New Philadelphia, OH (US); Terry Hill, Canton, OH (US)

(21) Appl. No.: 18/591,168

(22) Filed: Feb. 29, 2024

Related U.S. Application Data
(60) Provisional application No. 63/488,363, filed on Mar. 3, 2023.

(51) Int. Cl. B23B 35/00; B23B 45/00; B23B 51/04

(52) U.S. Cl. CPC B23B 35/00; B23B 45/00; B23B 51/04; E03C 2201/00

(57) ABSTRACT

A drain assembly removal tool for removing drain strainers or similar drain components from containers and basins. The drain assembly removal tool includes a guide plug that is adapted to engaged with and be seated at least partially inside of a drain strainer. The drain assembly removal tool also includes a pin that is operably engaged with the guide plug. The drain assembly removal tool also includes a cutting tool that is operably engaged with the pin and is adapted to cut into a flange of the drain strainer body. The pin of the drain assembly removal tool is also moveable between a first position and a second position relative to the guide plug when the guide plug is seated at least partially inside the drain strainer.

### REFERENCE TO RELATED APPLICATIONS

This application claims the benefit of U.S. Provisional Application Ser. No. 63/488,363, filed on Mar. 3, 2023; the disclosure of which is incorporated herein by reference.

### TECHNICAL FIELD

This disclosure is directed to a drain assembly removal tool, particularly a bathtub drain assembly removal tool, for removing a drain component from a bathtub.

### BACKGROUND ART

In many plumbing scenarios, drain pipe assemblies of bathtubs are normally removed and replaced with new drain pipe assemblies for various reasons, including blockage or clogs created in a drain pipe, cracks or fissures created in a drain pipe causing leaks, or upgrading the exterior hardware for stylist reasons (e.g., new drain covers and new drain strainers). However, such removal of drainage parts (e.g., drain strainers, drain plugs, etc.) from bathtubs are difficult for plumbers due to these drainage parts being corroded or adhered to drain pipes positioned underneath the bathtub. Moreover, removal of these drainage parts from bathtubs are also difficult for plumbers due to these drainage parts being adhered with drain pipes via welds or permanent bonding agents.

In order to combat this issue, drainage removal tools have been introduced into the plumbing market to tackle these issues. In one instance, a drainage removal tool may extend downwardly into the bathtub drain and engage with at least two spokes of a drain strainer body for releasably removing the drain strainer body from the bathtub. In this instance, however, such removal of the drain strainer body with this type of drainage removal tool still creates issues for the plumber because the spokes of the drain strainer body may shear off due to corrosion of the spokes or the corrosion permanently bonding the drain strainer body and the drain pipe together. In another instance, another drainage removal tool may extend downwardly into the bathtub drain and engage with a drain strainer body to cut an interior vertical side wall of the drain strainer body. In this instance, however, such cutting of the interior vertical side wall runs a risk of cutting into the bathtub thus marring or damaging the drainage opening defined in bathtub. In yet another instance, simple hand tools (e.g., a hammer and chisel) or portable reciprocating saw may be used to cut an interior wall of the drain strainer body. In this instance, however, such cutting of the interior wall runs a risk of cutting into the bathtub thus marring or damaging the drainage opening defined in bathtub.

### SUMMARY OF THE INVENTION

The presently disclosed drain assembly removal tool enables a plumber to cut a flange of a drain strainer body without marring or damaging the floor of the bathtub. The presently disclosed drain assembly removal tool includes a guide plug that engages with and is positioned inside of a drain strainer body. The guide plug guides a hole saw tool of the presently disclosed drain assembly removal tool when the hole saw tool cuts vertically downward into a flange of the drain strainer body. One exemplary embodiment of the presently disclosed drain assembly removal tool may also include a sealed bearing that operably engages with the guide plug to provide axial support or guidance to the hole saw tool during cutting operations. The presently disclosed drain assembly removal tool may also include at least one gasket that operably engages with the guide plug to frictional fit the guide plug inside of the drain strainer body during cutting operations. As such, the drain assembly removal tool disclosed herein addresses some of the inadequacies of previously known drain assembly removal tools.

In one aspect, an exemplary embodiment of the present disclosure may provide a drain assembly removal guide. The drain assembly removal guide includes a guide plug that is adapted to engage with and inside of a drain strainer body of a bathtub. The drain assembly removal guide also includes at least one gasket that operably engages about a portion of the guide plug and adapted to engage with an interior surface of the drain strainer body. The drain assembly removal guide also includes a hole saw tool having a blanked shank operably engaged with the guide plug and a hole saw blade positioned about the guide plug. The hole saw blade is configured to cut into a flange of the drain strainer body and free from contacting the bathtub.

In another aspect, an exemplary embodiment of the present disclosure may provide another drain assembly removal guide. The drain assembly removal guide includes a guide plug that is adapted to engage with and inside of a drain strainer body of a bathtub. The drain assembly removal guide also includes at least one gasket that operably engages about a portion of the guide plug and is adapted to engage with an interior surface of the drain strainer body. The drain assembly removal guide also includes a sealed bearing that operably engages with and inside of the guide plug. The drain assembly removal guide also includes a hole saw tool having a blanked shank operably engaged with the guide plug and a hole saw blade positioned about the guide plug. The hole saw blade is configured to cut into a flange of the drain strainer body and free from contacting the bathtub.

In yet another aspect, an exemplary embodiment of the present disclosure may provide another drain assembly removal guide. The drain assembly removal guide includes a guide plug adapted to engage with and inside of a drain strainer body of a bathtub. The drain assembly removal guide also includes at least one sealed bearing operably engaged with and inside of the guide plug. The drain assembly removal guide also includes a hole saw tool having a blanked shank operably engaged with the guide plug and a hole saw blade positioned about the guide plug. The drain assembly removal guide also includes a biaser operably engaged with the guide plug and the hole saw blade and positioned about the blanked shank for biasing the hole saw blade away from the guide plug; wherein the hole saw blade is configured to cut into a flange of the drain strainer body and free from contacting the bathtub.

In yet another aspect, an exemplary embodiment of the present disclosure may provide a method of removing a drain strainer body from a bathtub. The method includes steps of: engaging at least one gasket of a drain assembly removal guide with a guide plug of the drain assembly removal guide; collectively engaging the at least one gasket and the guide plug in the drain strainer body; engaging a portable drill with a hole saw tool of the drain assembly removal guide; introducing the hole saw tool to the guide plug; guiding the hole saw tool by the guide plug; cutting a flange of the drain strainer body from a threaded portion of the drain strainer body by the hole saw tool; and removing the drain strainer body from a bottom of the bathtub.

In yet another aspect, another exemplary embodiment of the present disclosure may provide a drain assembly removal tool. The drain assembly removal tool includes a guide plug that is adapted to engaged with and be seated at least partially inside of a drain strainer. The drain assembly removal tool also includes a pin that is operably engaged with the guide plug. The drain assembly removal tool also includes a cutting tool that is operably engaged with the pin and is adapted to cut into a flange of the drain strainer body; wherein the pin is moveable between a first position and a second position relative to the guide plug when the guide plug is seated at least partially inside the drain strainer.

This exemplary embodiment or another exemplary embodiment may further include at least one sealed bearing operably engaged with and inside of the guide plug and operably engaged with the pin. This exemplary embodiment or another exemplary embodiment may further include a biaser operably engaged with the guide plug and the pin; wherein the biaser is configured to apply a biasing force on the guide plug and the cutting tool. This exemplary embodiment or another exemplary embodiment may further include that the biaser comprises: a first end that operably engages with the cutting tool; and a second end opposite to the first end and the second end operably engages the guide plug. This exemplary embodiment or another exemplary embodiment may further include that the pin comprises: a head that operably engages with the guide plug; and a shaft extending from the head and the shaft operably engages the cutting tool. This exemplary embodiment or another exemplary embodiment may further include a connector that operably engages the shaft of the pin with the cutting tool; wherein the pin is removably engaged with the cutting tool. This exemplary embodiment or another exemplary embodiment may further include that the pin further comprises: an attachment cavity defined in the shaft of the pin; wherein the connector operably engages with the pin inside of the attachment cavity. This exemplary embodiment or another exemplary embodiment may further include that the guide plug comprises: a top end; a bottom end opposite to the top end; a passageway defined between the top end and the bottom end; wherein the at least one sealed bearing is positioned within the guide plug inside of the passageway. This exemplary embodiment or another exemplary embodiment may further include that the guide plug further comprises: a shoulder extending into the passageway and positioned at a location between the top end and the bottom end; wherein the at least one sealed bearing is adjacent the shoulder and is positioned between the top end and the shoulder. This exemplary embodiment or another exemplary embodiment may further include at least another sealed bearing operably engaged with and inside of the guide plug and operably engaged with the pin; wherein the at least another sealed bearing operably engages with the shoulder and is positioned between the bottom end and the shoulder. This exemplary embodiment or another exemplary embodiment may further include at least one gasket operably engaged with the guide plug; wherein the at least one gasket is configured to extend beyond an plug portion of the guide plug. This exemplary embodiment or another exemplary embodiment may further include that the guide plug further comprises: a top end; a bottom end opposite to the top end; and a groove defined in the guide plug between the top end and the bottom end; wherein the at least one gasket is configured to be received by the groove. This exemplary embodiment or another exemplary embodiment may further include that the guide plug further comprises: a head portion; and a plug portion extending from the head portion; wherein at least the plug portion is adapted to be engaged with and be positioned inside of the drain strainer.

In yet another aspect, another exemplary embodiment of the present disclosure may provide a method of removing a drain strainer from a container. The method includes steps of: engaging a portable drill with a drain assembly removal tool, the drain assembly removal tool having a pin connected to a guide plug, wherein the pin is moveable between a first position and a second position, and the drain assembly removal tool having a cutting tool; installing the guide plug in the drain strainer; guiding the cutting tool by the guide plug being installed in the drain strainer; cutting, with the cutting tool being driven by the portable drill, a flange of the drain strainer from a threaded portion of the drain strainer; and removing the drain strainer from the container.

This exemplary embodiment or another exemplary embodiment may further include a step of supporting the pin, by at least one sealed bearing of the drain assembly removal tool, along a rotational axis of the pin. This exemplary embodiment or another exemplary embodiment may further include a step of applying a biasing force to the guide plug, by a biaser of the drain assembly removal tool, that maintains the guide plug at the first position; wherein a portion of the guide plug is positioned external to the cutting tool. This exemplary embodiment or another exemplary embodiment may further include steps of applying an external force on the guide plug and the cutting tool, wherein the external force is greater than the biasing force of the guide plug; and moving the guide plug along the pin from the first position to the second position; wherein the cutting tool completely surrounds the guide plug in the second position. This exemplary embodiment or another exemplary embodiment may further include a step of engaging the at least one sealed bearing inside a passageway defined by the guide plug between a first end of the guide plug and a shoulder positioned inside of the passageway. This exemplary embodiment or another exemplary embodiment may further include a step of engaging at least another sealed bearing inside of the passageway between a second end of the guide plug that is opposite to the first end and the shoulder; and supporting the pin, by at least another sealed bearing of the drain assembly removal guide, along the rotational axis of the pin. This exemplary embodiment or another exemplary embodiment may further include steps of engaging at least one gasket of the drain assembly removal tool with the guide plug of the drain assembly removal tool; and engaging the at least one gasket inside of the drain strainer.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a partial sectional view of a bathtub and a drainage system, wherein a drain assembly removal tool in accordance with an aspect of the present disclosure operably engages with a drain strainer body of the drainage system.

FIG. 2 (FIG. 2) is an exploded view of the drain assembly removal tool shown in FIG. 1 along with a hole saw.

FIG. 3 (FIG. 3) is a front elevation view of a guide plug of the drain assembly removal tool.

FIG. 4A (FIG. 4A) is a bottom plan view of the guide plug, wherein a sealed bearing of the drain assembly removal tool operably engages with the guide plug.

FIG. 4B (FIG. 4B) is a bottom plan view of the guide plug, wherein the sealed bearing is removed from the guide plug.

FIG. 5 (FIG. 5) is a longitudinal sectional view of the guide plug, the sealed bearing, and first and second gaskets of the drain assembly removal tool taken in the direction of lines 5-5 in FIG. 4A.

FIG. 6 (FIG. 6) is a cross-sectional view of the guide plug taken in the direction of lines 6-6 in FIG. 3, wherein the sealed bearing and the first and second gaskets are removed.

FIG. 7A (FIG. 7A) is an operational view of the drain assembly removal tool, wherein the guide plug and the first and second gaskets engage with the drain strainer body.

FIG. 7B (FIG. 7B) is another operational view similar to FIG. 7A, but a hole saw tool of the drain assembly removal tool is introduced to the guide plug and the sealed bearing along with the drain strainer body, wherein the hole saw tool is operably engaged with a portable drill.

FIG. 7C (FIG. 7C) is another operational view similar to FIG. 7B, but the hole saw tool cuts into a flange of the drain strainer body via rotation applied by the portable drill.

FIG. 7D (FIG. 7B) is another operational view similar to FIG. 7C, but the flange of the drain strainer body and a threaded portion of the drain strainer body are separated from one another by the hole saw tool.

FIG. 8 (FIG. 8) is an exploded view of another drain assembly removal tool shown in accordance with another aspect of the present disclosure.

FIG. 9A (FIG. 9A) is a sectional view of the drain assembly removal tool shown in FIG. 8, wherein the drain assembly removal tool is provided in a first configuration.

FIG. 9B (FIG. 9B) is a sectional view of the drain assembly removal tool shown in FIG. 8, wherein the drain assembly removal tool is provided in a second configuration.

FIG. 10 (FIG. 10) is an exemplary method flowchart of removing a drain strainer body from a bathtub.

FIG. 11 (FIG. 11) is an exploded view of another drain assembly removal tool shown in accordance with another aspect of the present disclosure.

FIG. 12 (FIG. 12) is a sectional view of the drain assembly removal tool shown in FIG. 11.

FIG. 13 (FIG. 13) is an exemplary method flowchart of removing a drain strainer from a container.

Similar numbers refer to similar parts throughout the drawings.

### DETAILED DESCRIPTION

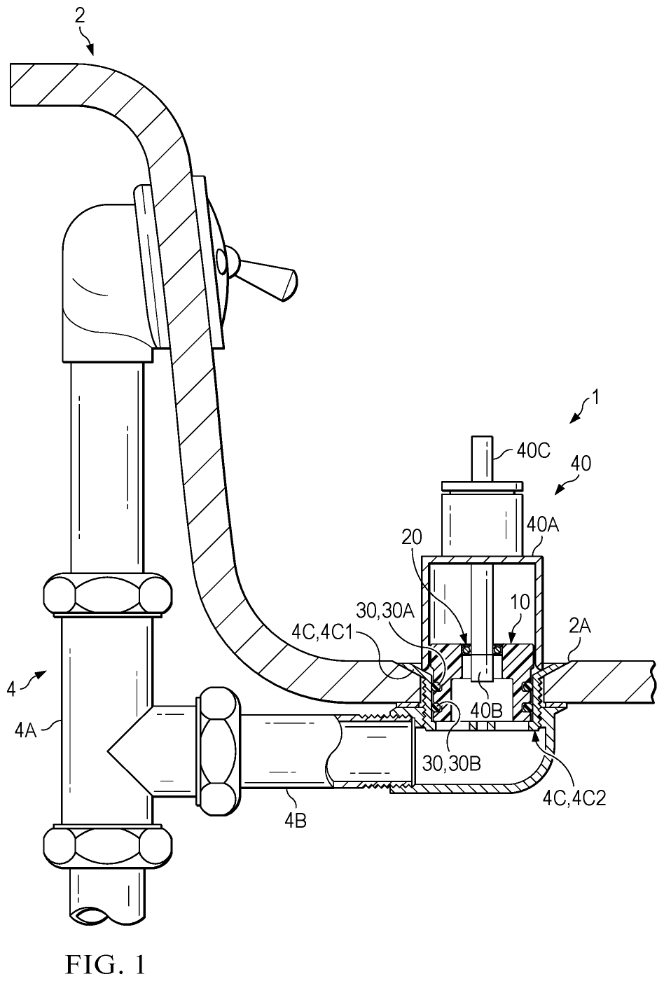

FIG. 1 illustrates a first embodiment of a drain assembly removal tool, generally referred to as 1 herein, for cutting and removing a drain pipe system 4 from a bathtub 2 or similar container for holding water in which a person may use for bathing purposes. As described in greater detail below, the drain assembly removal tool 1 is configured to be placed inside of a drain opening 2A defined by the bathtub 2 for cutting a drain strainer body 4C of the drain pipe system 4, particularly a flange 4C1 of the drain strainer body 4C away from a threaded portion 4C2 of the drain strainer body 4C. Such cutting of the drain strainer body 4C enables a plumber to remove a second drain pipe 4B and the drain strainer body 4C from the bathtub 2 and a first drain pipe 4A without damaging or marring an interior surface of the bathtub 2. Such parts and components that form the drain assembly removal tool 1 are described in greater detail below.

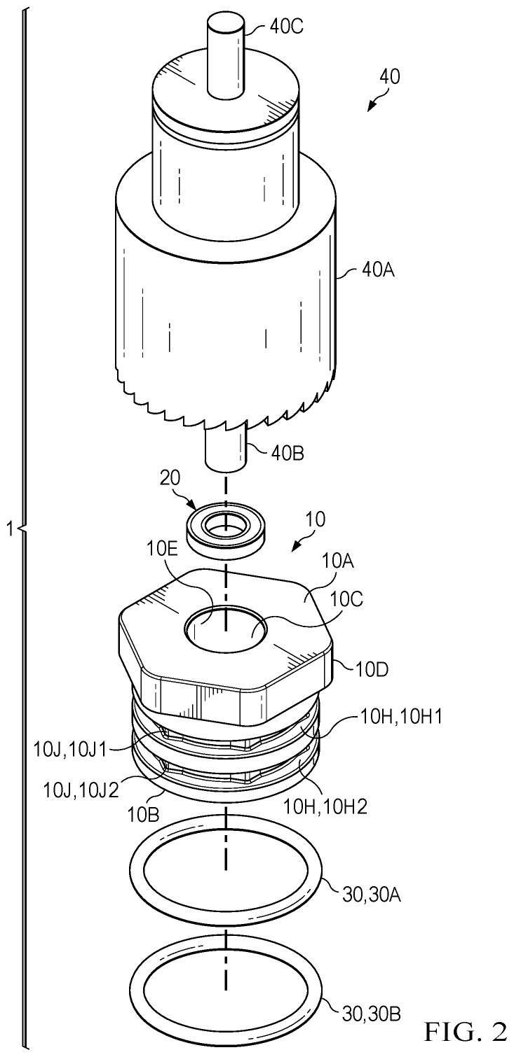

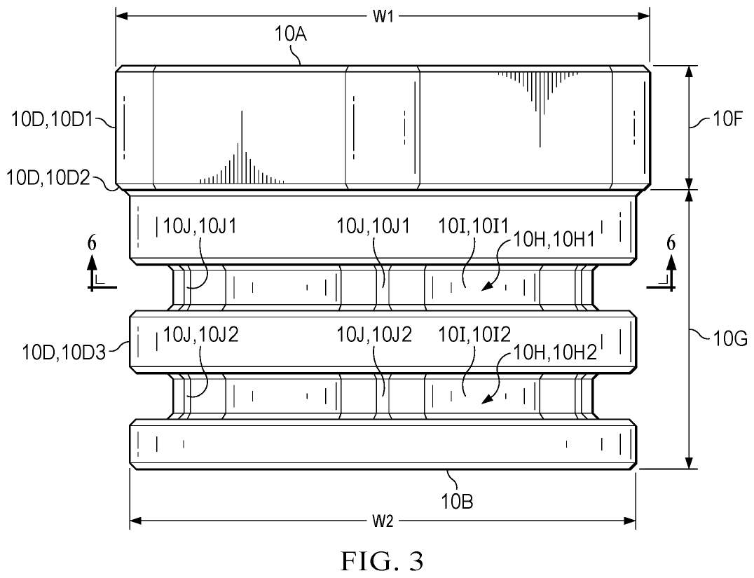

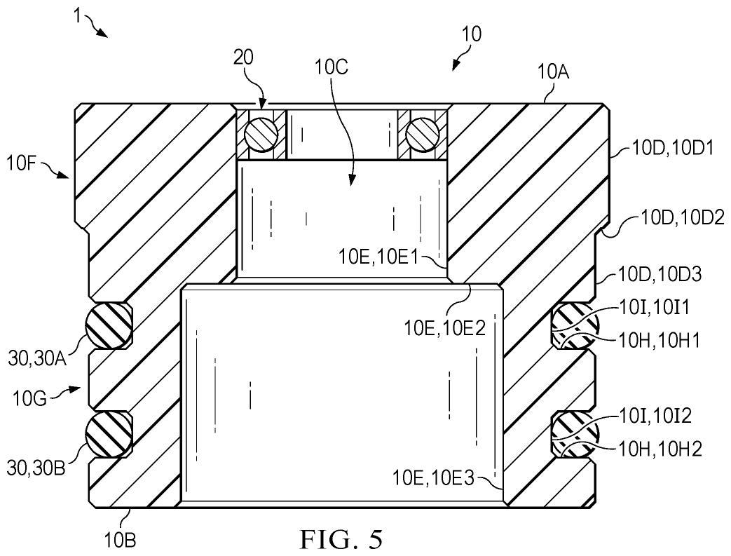

As best seen in FIGS. 2-6, drain assembly removal tool 1 includes a guide plug or guide bushing 10 that is adapted to operably engage with the drain strainer body 4C inside of the drain opening 2A defined in the bathtub 2. More particularly, the guide plug 10 is adapted to operably engage with at least the threaded portion 4C2 of the drain strainer body 4C inside of the drain opening 2A defined in the bathtub 2. As best seen in FIGS. 3 and 5, guide plug 10 includes a top end 10A, an open bottom end 10B vertically opposite to the top end 10A, and a longitudinal axis defined therebetween. As best seen in FIG. 5, guide plug 10 also defines a passageway 10C that extends entirely through the guide plug 10 along the longitudinal axis of the guide plug 10 between the top end 10A and the bottom end 10B. Top end 10A is substantially enclosed except for the portion of top end 10A that is open as defined by the passageway 10C.

Guide plug 10 also includes an exterior wall 10D that extends along the entire length of the guide plug 10. As best seen in FIGS. 3 and 5, guide plug 10 includes an upper exterior wall 10D1 that extends downwardly from the top end 10A to an exterior shoulder 10D2. Guide plug 10 also includes a lower exterior wall 10D3 that extends downwardly from the exterior shoulder 10D2 to the bottom end 10B. As such, the upper exterior wall 10D1, the exterior shoulder 10D2, and the lower exterior wall 10D3 collectively define the exterior wall 10D of the guide plug 10.

Guide plug 10 also includes an interior wall 10E that extends along the entire length of the guide plug 10 opposing the exterior wall 10D. As best seen in FIG. 5, guide plug 10 includes an upper interior wall 10E1 that extends downwardly from the top end 10A to an interior shoulder 10E2. Guide plug 10 also includes a lower interior wall 10E3 that extends downwardly from the interior shoulder 10E2 to the bottom end 10B. As such, the upper interior wall 10E1, the interior shoulder 10E2, and the lower interior wall 10E3 collectively define the interior wall 10E. The diameter of the lower interior wall 10E3 is greater than the diameter of the upper interior wall 10E1.

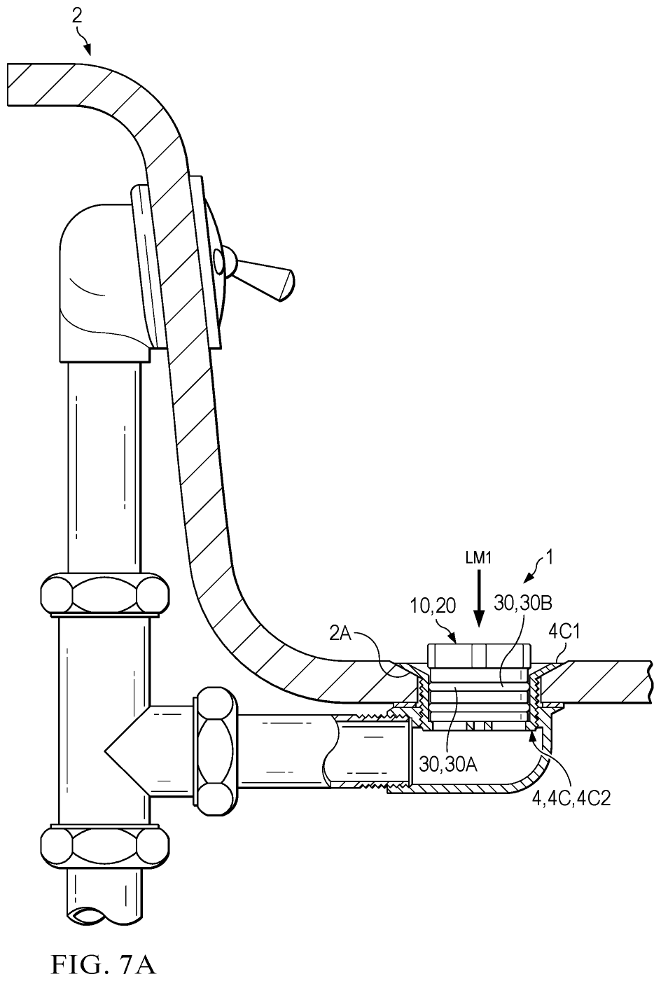

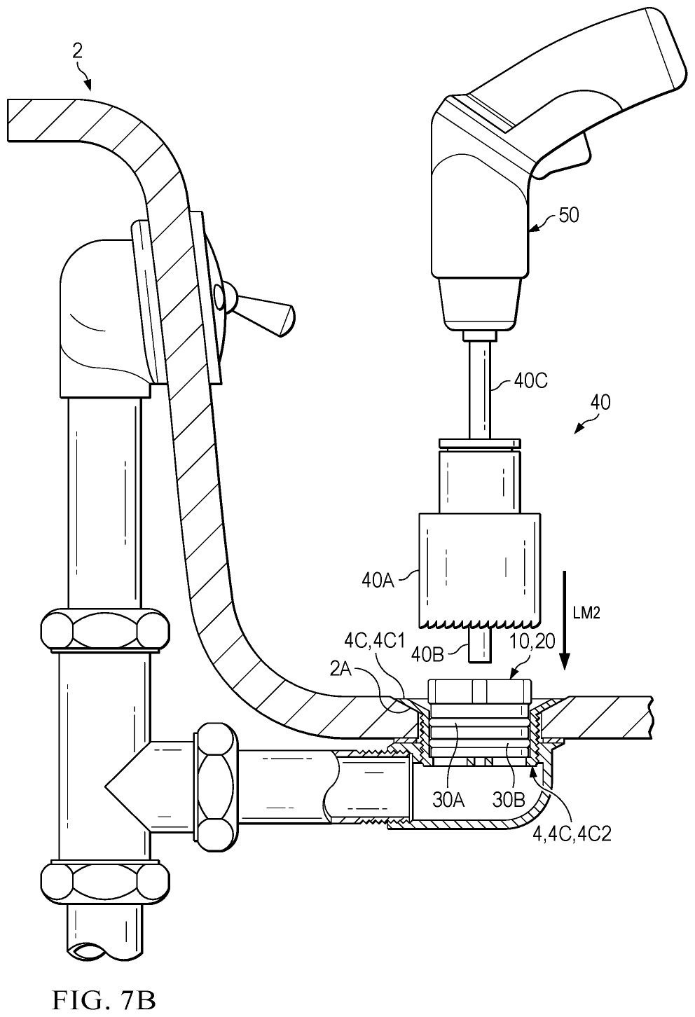

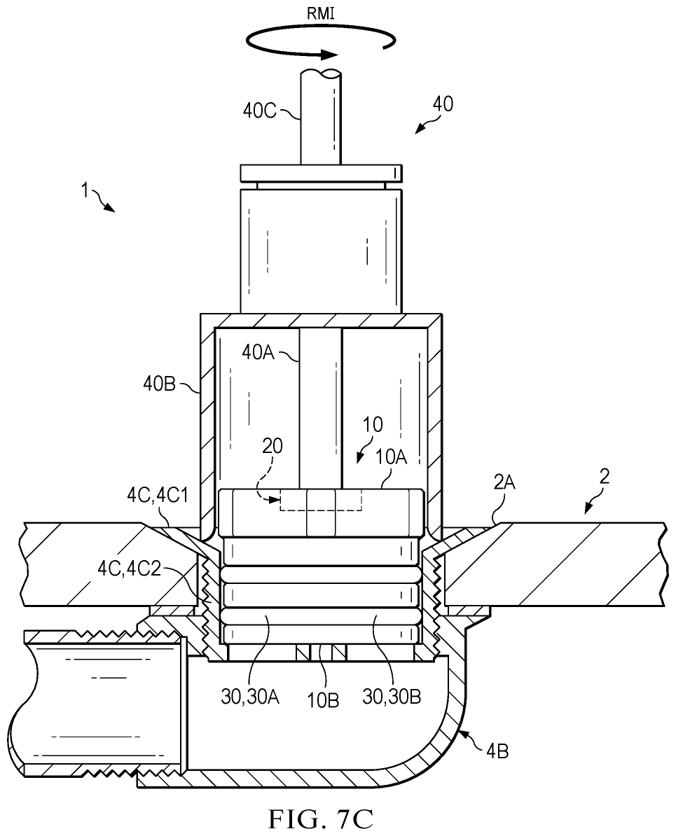

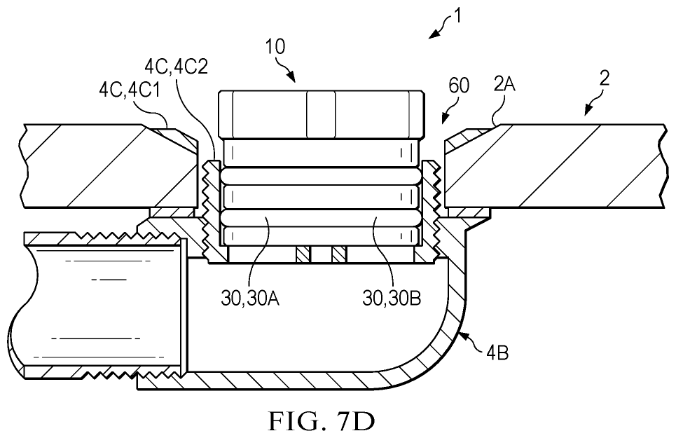

Referring to FIGS. 3 and 5, guide plug 10 also includes a head portion 10F that extends downwardly from the top end 10A to the exterior shoulder 10D2. The upper exterior wall 10D1 is part of head portion 10F. During operation, head portion 10F may be positioned vertically above the drain opening 2A of the bathtub 2 as well as the drain strainer body 4C when the drain assembly removal tool 1 cuts the drain strainer body 4C (see FIG. 7A) such that shoulder 10D2 rests on flange 4C1. Still referring to FIGS. 3 and 5, guide plug 10 also includes a plug portion 10G that extends downwardly from the head portion 10F to the bottom end 10B. During operation, plug portion 10G is positioned inside of the drain opening 2A of the bathtub 2 as well as being positioned inside of and operably engaged with the drain strainer body 4C when the drain assembly removal tool 1 cuts the drain strainer body 4C.

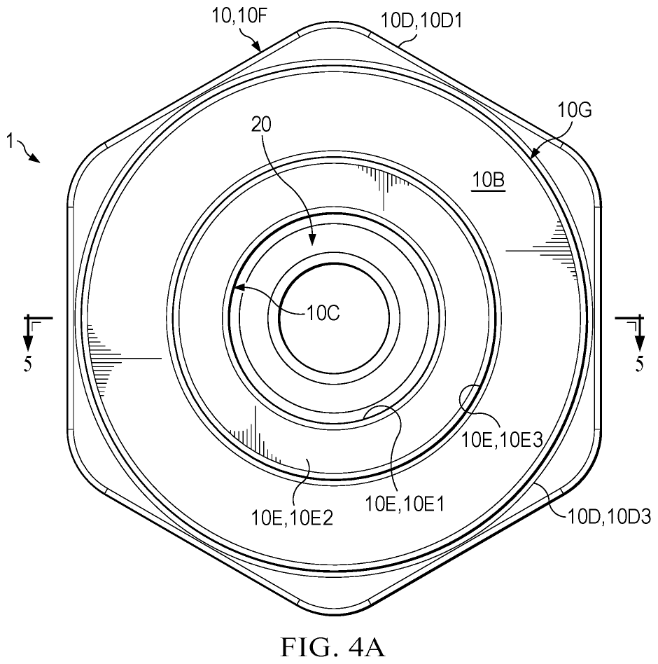

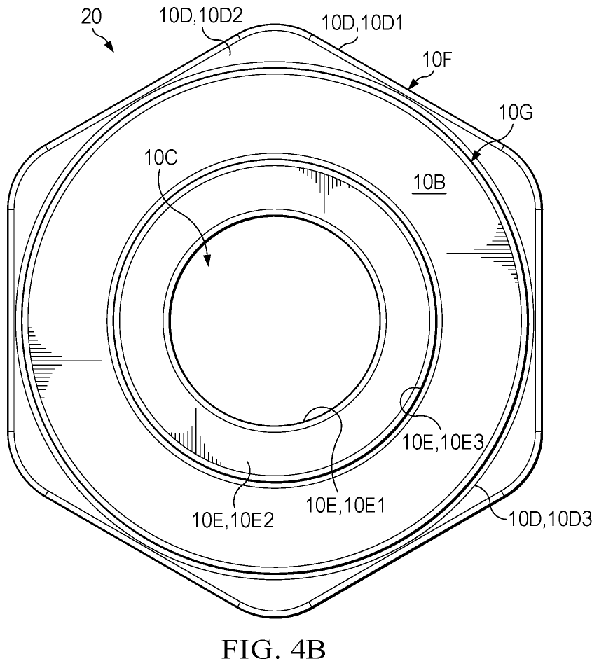

Guide plug 10 may also define at least two widths along the head portion 10F and plug portion 10G. As best seen in FIG. 3, guide plug 10 may define a first diameter or width “W1” that extends along the entire length of the head portion 10F. Guide plug 10 may define a second diameter or width “W2” that extends along the entire length of the plug portion 10G where the second diameter “W2” is less than the first diameter “W1” defined along the head portion 10F. In other exemplary embodiments, guide plug 10 may define any suitable diameters along the head portion 10F and the plug portion 10G dictated by the implementation of the guide plug 10. When viewed in a plan view (see FIGS. 4A-4B), the head portion 10F has a generally hexagonal configuration.

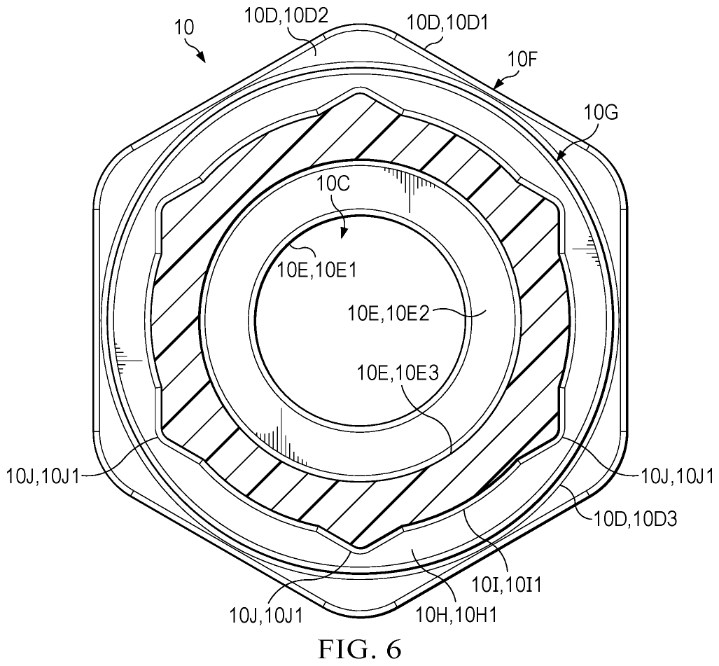

Guide plug 10 also defines at least one groove 10H that extends radially around the exterior wall 10D inward towards at least one intermediate surface 10I positioned between the exterior wall 10D and the interior wall 10E. As best seen in FIGS. 3 and 6, guide plug 10 defines a first groove 10H1 that extends radially into the guide plug 10 from the exterior wall 10D towards a first intermediate surface 10I1. Guide plug 10 also defines a second groove 10H2 that extends radially into the guide plug 10 from the exterior wall 10D towards a second intermediate surface 10I2. As best seen in FIGS. 3 and 6, the first groove 10H1 and the second groove 10H2 are defined in the plug portion 10G. The first groove 10H1 is also positioned vertically above the second groove 10H2. Such use and purpose of the first groove 10H1 and the second groove 10H2 is described in greater detail below.

Guide plug 10 may also define a first set of ridges 10J that extend outwardly from the at least one groove 10H at an intermediate surface 10I. As best seen in FIGS. 3 and 6, guide plug 10 may define a first set of ridges 10J1 that extend outwardly from the first groove 10H1 at a first intermediate surface 10I1. Still referring to FIGS. 3 and 6, guide plug 10 may also define a second set of ridges 10J2 that extend outwardly from the second groove 10H2 at a second intermediate surface 10I2. As described in greater detail below, the first set of ridges 10J1 and the second set of ridges 10J2 enable a first gasket of the drain assembly removal tool 1 and a second gasket of the drain assembly removal tool 1 to be pushed radially outwards by the sets of ridges to enable the “pushed out” portions of the gasket or O-ring to engage with the drain strainer body 4C to prevent the guide plug 10 from slipping and/or disengaging from the drain strainer body 4C when cutting the drain strainer body 4C via a hole saw tool of the drain assembly removal tool 1. In one exemplary embodiment, one or both of the first set of ridges 10J1 and the second set of ridges 10J2 may be omitted from the guide plug 10 if desired as dictated by the implementation of the guide plug 10 (e.g., removal of gaskets, size of gaskets, etc.).

While drain assembly removal tool 1 includes the guide plug 10 described and illustrated herein, it should be appreciated that guide plug 10 may have suitable size, shape, and configuration to match with conventional or commercially-available drain strainer bodies. In one example, guide plug may have a smaller diameter than the first diameter “W1” and the second diameter “W2” of guide plug 10 for smaller drain strainer bodies as compared to drain strainer body 4C referenced herein. In another example, guide plug may also have a larger diameter than the first diameter “W1” and the second diameter “W2” of guide plug 10 for larger drain strainer bodies as compared to drain strainer body 4C referenced herein.

While drain assembly removal tool 1 includes the guide plug 10 described and illustrated herein, it should also be appreciated that drain assembly removal tool 1 may include one or more guide plugs similar to guide plug 10 with varying diameters and/or widths to match with conventional or commercially-available drain strainer bodies. In one example, drain assembly removal tool 1 may include at least one guide plug that has a smaller diameter than the first diameter “W1” and the second diameter “W2” of guide plug 10 for smaller drain strainer bodies as compared to drain strainer body 4C referenced herein. In another example, drain assembly removal tool 1 may include at least another guide plug that has a larger diameter than the first diameter “W1” and the second diameter “W2” of guide plug 10 for larger drain strainer bodies as compared to drain strainer body 4C referenced herein.

Drain assembly removal tool 1 may also include a sealed bearing 20 that operably engages with and is positioned inside of the guide plug 10. As best seen in FIGS. 4A and 5, the sealed bearing 20 is configured to engage with the head portion 10F inside of the passageway 10C proximate to the top end 10A, particularly the upper interior wall 10E1 of the guide plug 10. As described in greater detail below, the sealed bearing 20 is configured to receive and engage with a blanked shank or arbor of a hole saw tool of the drain assembly removal tool 1 to help rotationally guide the hole saw tool when the hole saw tool cut into the drain strainer body 4C of drain pipe system. Alternatively, a drill bit could be utilized instead of the blanked shank or arbor, however this may not be as desirable because the drill bill could damage the bearing.

It should be appreciated that drain assembly removal tool 1 may use any commercially-available sealed bearing for sealed bearing 20 that is configured to receive and engage with a blanked shank of a hole saw tool of the drain assembly removal tool 1 to help rotationally guide the hole saw tool when the hole saw tool cut into the drain strainer body 4C of drain pipe system. Examples of suitable sealed bearings for drain assembly removal tool 1 include sealed ball bearings, sealed thrust ball bearings, dry-running sleeve bearings, sealed roller bearings, and other suitable sealed bearings of the like. In the illustrated embodiment, sealed bearing 20 is a conventional sealed ball bearing that engages with the guide plug 10. It should also be appreciated that sealed bearing 20 may also be omitted from drain assembly removal tool 1 if desired.

Drain assembly removal tool 1 may also include at least one gasket or O-ring 30 that operably engages with the guide plug 10 inside of the at least one groove 10H. As best seen in FIG. 5, drain assembly removal tool 1 may include a first gasket 30A that operably engages with the guide plug 10 inside of the first groove 10H1. The first gasket 30A may also operably engage with each ridge of the first set of ridges 10J1 in which portions of the first gasket 30A are positioned outside of the first groove 10H1 to enable the first gasket 30A to frictional fit with the drain strainer body 4C (see FIGS. 1 and 7A-7D). Still referring to FIG. 5, drain assembly removal tool 1 may also include a second gasket 30B that operably engages with the guide plug 10 inside of the second groove 10H2. Similar to the first gasket 30A, the second gasket 30B may also operably engage with each ridge of the second set of ridges 10J2 in which portions of the second gasket 30B are positioned outside of the second groove 10H2 to enable the second gasket 30B to frictional fit with the drain strainer body 4C (see FIGS. 1 and 7A-7D).

It should be appreciated that drain assembly removal tool 1 may use any commercially-available gaskets for first gasket 30A and second gasket 30B that are configured to frictionally fit with the drain strainer body 4C to prevent the guide plug 10 from slipping or moving inside of the drain strainer body 4C. In one instance, a first gasket and a second gasket may be made from resilient, elastic material that may frictionally fit with a drain strainer body to prevent a guide plug mentioned herein from slipping or moving inside of the drain strainer body. It should also be appreciated that one or both of the first gasket 30A and the second gasket 30B may also be omitted from drain assembly removal tool 1 if desired.

Drain assembly removal tool 1 may also include a hole saw tool 40 that operably engaged with the guide plug 10, via the sealed bearing 20, and configured to encase the guide plug 10 when cutting into the drain strainer body 4C, particularly the flange 4C1 of the drain strainer body 4C.

Hole saw tool 40 includes a hole saw blade 40A that is configured to cut into the drain strainer body 4C (e.g., metal materials) while being free from contacting the guide plug 10. As best seen in FIG. 7C, the hole saw blade 40A defines an inner diameter that is greater than the first diameter “W1” of guide plug 10 which prevents the hole saw blade 40A from contacting the guide plug 10 when cutting into the drain strainer body 4C. During operation, the hole saw blade 40A that is configured to cut into the flange 4C1 of the drain strainer body 4C to separate the flange 4C1 and the threaded portion 4C2 of the drain strainer body 4C for ease of removing the drain strainer body 4C and the second drain pipe 4B from the bathtub 2.

Hole saw tool 40 also includes a blanked shank 40B that operably engages with the hole saw blade 40A and the guide plug 10. In the illustrated embodiment, the blanked shank 40B is configured to be received and housed inside of the sealed bearing 20 to enable the sealed bearing 20 to rotationally guide the hole saw tool 40 as the hole saw blade 40A rotates and cuts into the flange 4C1 of the drain strainer body 4C. Stated differently, the blanked shank 40B couples with the sealed bearing 20 to maintain a linear cutting direction of hole saw blade 40A while the hole saw tool 40 freely rotates about the guide plug 10 via rotational force applied by a power tool 50 (e.g., a portable drill or similar power tool of the like). Hole saw tool 40 also includes an attachment shank 40C that is continuous with the blanked shank 40B. The attachment shank 40C enables the power tool 50 (separate from the drain assembly removal tool 1) to engage with the hole saw tool 40 and to automatically rotate the hole saw blade 40A for cutting into the drain strainer body 4C.

While the hole saw tool 40 operably engages with the sealed bearing 20, via the blanked shank 40B, the blanked shank 40B may also be positioned inside of the guide plug 10 and freely move inside of the guide plug 10 if the sealed bearing 20 is omitted. In this instance, hole saw tool 40, as well as other commercially available hole saw tools, may be used with guide plug 10 for cutting into the flange 4C1 of the drain strainer body 4C.

While drain assembly removal tool 1 includes hole saw tool 40 described and illustrated herein, it should be appreciated that drain assembly removal tool 1 may include one or more hole saw blades, similar to hole saw blade 40A, with varying diameters and/or widths to match with conventional or commercially-available drain strainer bodies. In one example, drain assembly removal tool 1 may include at least one hole saw blade that has a smaller diameter than the hole saw blade 40A described and illustrated herein for at least one guide plug that has a smaller diameter than the first diameter “W1” and the second diameter “W2” of guide plug 10 for smaller drain strainer bodies as compared to drain strainer body 4C referenced herein. In another example, drain assembly removal tool 1 may include at least another hole saw blade that has a larger diameter than hole saw blade 40A for at least one guide plug that has a larger diameter than the first diameter “W1” and the second diameter “W2” of guide plug 10 and for larger drain strainer bodies as compared to drain strainer body 4C referenced herein.

Having now described the parts and components of the drain assembly removal tool 1, a method of cutting at least one drain strainer body 4C via the drain assembly removal tool 1 is described in greater detail below.

Prior to cutting the drain strainer body 4C, a user of the drain assembly removal tool 1 (e.g., a plumber) would initially determine if the guide plug 10 is configured to engage with and inside of the drain strainer body 4C. As discussed previously, drain assembly removal tool 1 may include one or more guide plugs 10 defining various diameters that match with various commercially-available or conventional drain strainer bodies. In this illustrated embodiment, however, guide plug 10 will be chosen for brevity and demonstrative purposes as to how the guide plug 10 operably engages with and is positioned inside of the drain strainer body 4C.

Once the guide plug 10 is chosen, the plumber then presses the guide plug 10 (at or near the top end 10A) vertically downward into the drain strainer body 4C and into the drain opening 2A of the bathtub 2 (see FIG. 7A). Such linear movement of the guide plug 10 into the drain strainer body 4C is denoted by an arrow labeled “LM1” in FIG. 7A. As the guide plug 10 is introduced into the drain strainer body 4C, the first gasket 30A and the second gasket 30B frictionally engage with the interior wall of the drain strainer body 4C as the guide plug 10 moves vertically downward into the drain strainer body 4C. Such frictional engagement between the first gasket 30A and the second gasket 30B and the guide plug 10 may provide a tight seal engagement between the guide plug 10 and the drain strainer body 4C so that the guide plug 10 is prevented from rotating or shifting inside of the drain strainer body 4C during a cutting operation. In addition to the first gasket 30A and the second gasket 30B, the exterior wall 10D of the guide plug 10 may frictional fit against the interior wall of the drain strainer body 4C based on the deformation of the first gasket 30A and the second gasket 30B. The plumber may continue to press the guide plug 10 into the drain strainer body 4C until the bottom end 10B of the guide plug 10 interfaces with a base wall of the drain strainer body 4C or until the plug portion 10G is prevented from moving based on the structural configuration of drain strainer body 4C.

Once the guide plug 10 is operably engaged with and inside of the drain strainer body 4C, the plumber may then introduce the hole saw tool 40 to the guide plug 10 where the hole saw tool 40 operably engages with a portable drill 50. As best seen in FIG. 7B, the portable drill 50 operably engages with the attachment shank 40C of the hole saw tool 40 to spin the hole saw tool 40 about the longitudinal axis of the attachment shank 40C for cutting purposes. The plumber may move the hole saw tool 40 and the portable drill 50 towards the guide plug 10 and the drain strainer body 4C until the hole saw blade 40A contacts and interfaces with the drain strainer body 4C, particularly the flange 4C1 of the drain strainer body 4C; such linear movement of the hole saw tool 40 and the portable drill 50 into the drain strainer body 4C is denoted by an arrow labeled “LM2” in FIG. 7B.

As the plumber moves the hole saw tool 40 towards the guide plug 10, the hole saw blade 40A passes over the guide plug 10 where the hole saw blade 40A encapsulates the guide plug 10 inside of the hole saw blade 40A. As best seen in FIG. 7C, the blanked shank 40B also passes through the top end 10A of the guide plug 10 and into the passageway 10C of the guide plug 10 as the plumber moves the hole saw tool 40 towards the guide plug 10. As best seen in FIG. 1, the blanked shank 40B also passes through and operably engages with the sealed bearing 20 as the hole saw tool 40 is introduced to the guide plug 10 and the drain strainer body 4C. If, however, the sealed bearing 20 is omitted from the drain assembly removal tool 1, the blanked shank 40B is positioned inside of the passageway 10C of the guide plug 10 and may be spaced apart from the interior wall 10E of guide plug 10.

Once the hole saw tool 40 is positioned with the guide plug 10, the sealed bearing 20, and the drain strainer body 4C, the plumber may then initiate the hole saw tool 40 to cut into the drain strainer body 4C, particularly the flange 4C1, via rotational movement applied by the portable drill 50. Such rotational movement of the hole saw tool 40 applied by the portable drill 50 is denoted by an arrow labeled “RM1” in FIG. 7C. As the hole saw tool 40 cuts into the flange 4C1 of the drain strainer body 4C, the sealed bearing 20 provides axial support and guidance to the blanked shank 40B as the hole saw tool 40 moves vertically downward into flange 4C1. During this cutting operation, the guide plug 10 also remains frictional fit with the drain strainer body 4C so that the sealed bearing 20 also remains in a fixed position for providing axial support and guidance to the blanked shank 40B as the hole saw tool 40 cuts into the drain strainer body 4C.

The plumber may continue to cut into the flange 4C1 of the drain strainer body 4C with the hole saw tool 40 until the hole saw tool 40 completely cuts through the flange 4C1. As best seen in FIG. 7D, the hole saw tool 40 cuts a circumferential hole 60 inside of the drain strainer body 4C that separates the flange 4C1 and the threaded portion 4C2 from one another. While not illustrated herein, a small gap may be defined between the drain strainer body 4C and the drain opening 2A that prevents the hole saw blade 40A from cutting into and marring the bathtub 2 during this cutting process. Once the drain strainer body 4C is cut, the plumber may then remove the hole saw tool 40 from the guide plug 10 and the sealed bearing 20 and away from the bathtub 2. The plumber may then remove the guide plug 10 and the flange 4C1 of the drain strainer body 4C from the drain opening 2A of the bathtub 2. Once removed, the plumber may then downwardly press or pull the threaded portion 4C2 of the drain strainer body 4C from the drain opening 2A such that the threaded portion 4C2 of the drain strainer body 4C and second drain pipe 4B are removed from below the bathtub 2.

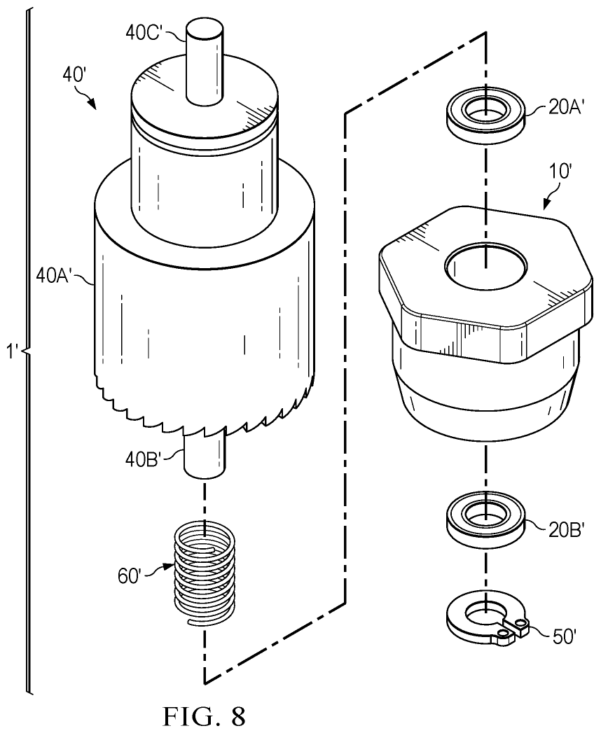

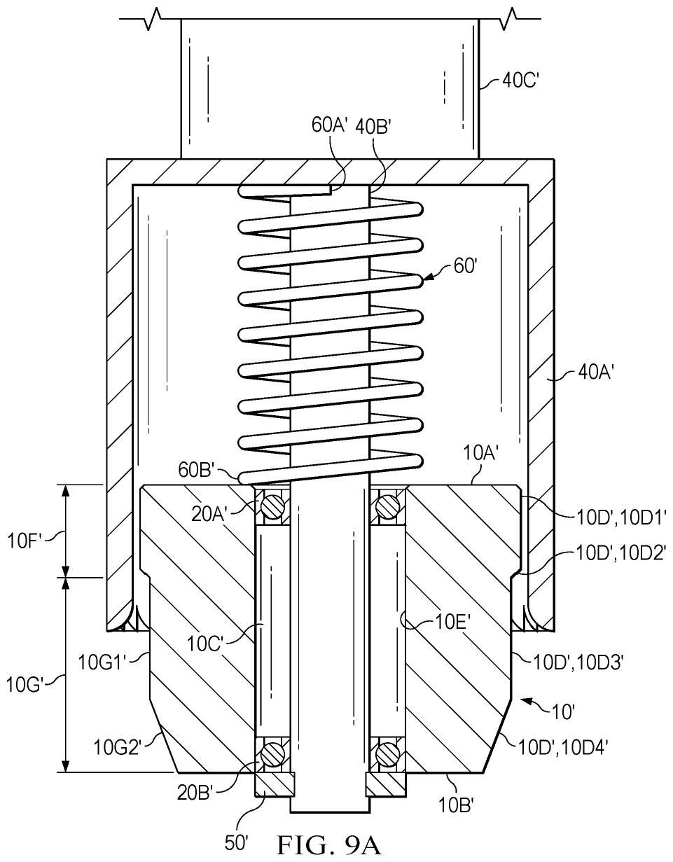

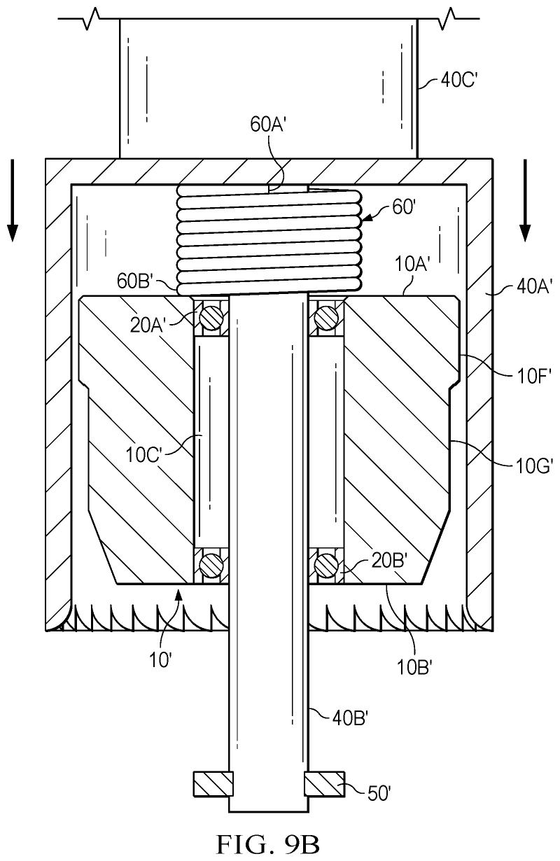

FIGS. 8-9B illustrate another embodiment of drain assembly removal tool 1′. Drain assembly removal tool 1′ is substantially similar to drain assembly removal tool 1 described above and illustrated in FIGS. 1-7D, except as detailed below.

Drain assembly removal tool 1′ includes a guide plug or guide bushing 10′ that is adapted to operably engage with the drain strainer body 4C inside of the drain opening 2A defined in the bathtub 2. During a cutting operation, the guide plug 10′ is adapted to operably engage with at least the threaded portion 4C2 of the drain strainer body 4C inside of the drain opening 2A defined in the bathtub 2. As best seen in FIGS. 9A-9B, guide plug 10′ includes a top end 10A′, an open bottom end 10B′ vertically opposite to the top end 10A′, and a longitudinal axis defined therebetween. As best seen in FIGS. 9A-9B, guide plug 10′ also defines a passageway 10C′ that extends entirely through the guide plug 10′ along the longitudinal axis of the guide plug 10′ between the top end 10A′ and the bottom end 10B′. Top end 10A′ is substantially enclosed except for the portion of top end 10A′ that is open as defined by the passageway 10C′.

Guide plug 10′ also includes an exterior wall 10D′ that extends along the entire length of the guide plug 10′. As best seen in FIGS. 9A-9B, guide plug 10′ includes an upper exterior wall 10D1′ that extends downwardly from the top end 10A′ to an exterior shoulder 10D2′. Guide plug 10′ also includes a first lower exterior wall 10D3′ that extends downwardly from the exterior shoulder 10D2′ towards the bottom end 10B′. Guide plug 10′ also includes a second lower exterior wall 10D3′ that extends downwardly from the first lower exterior wall 10D3′ to the bottom end 10B′. As best seen in FIGS. 9A-9B, the second lower exterior wall 10D4′ also tapers inwardly as the second lower exterior wall 10D4′ extends downwardly from the first lower exterior wall 10D3′ to the bottom end 10B′. As such, the upper exterior wall 10D1′, the exterior shoulder 10D2′, the first lower exterior wall 10D3′, and the second lower exterior wall 10D4′ collectively define the exterior wall 10D′ of the guide plug 10′.

Guide plug 10′ also includes an interior wall 10E′ that extends along the entire length of the guide plug 10′ opposing the exterior wall 10D′. As best seen in FIGS. 9A-9B, the interior wall 10E′ is continuous and uninterrupted between the top end 10A′ and the bottom end 10B′ for defining the passageway 10C′. It should be appreciated that the interior wall 10E′ of guide plug 10′ may include additional features as discussed herein, including the upper interior wall 10E1, the interior shoulder 10E2, or the lower interior wall 10E3 collectively define the interior wall 10E of guide plug 10.

Referring to FIGS. 9A-9B, guide plug 10′ also includes a head portion 10F′ that extends downwardly from the top end 10A′ to the exterior shoulder 10D2′. The upper exterior wall 10D1′ and the exterior shoulder 10D2′ are part of head portion 10F′. During operation, head portion 10F′ may be positioned vertically above the drain opening 2A of the bathtub 2 as well as the drain strainer body 4C when the drain assembly removal tool 1′ cuts the drain strainer body 4C such that shoulder 10D2′ rests on flange 4C1.

Guide plug 10′ also includes a plug portion 10G′ that extends downwardly from the head portion 10F′ to the bottom end 10B′. As best seen in FIGS. 9A-9B, the plug portion 10G′ includes a first plug section 10G1′ that extends downwardly from the head portion 10F′ toward the bottom end 10B′. The first plug section 10G1′ may also define a continuous width or diameter along the entire length defining the first plug section 10G1′. The plug portion 10G′ also includes a second plug section 10G1′ that extends downwardly from the first plug portion 10G1′ to the bottom end 10B′. The second plug section 10G2′ may also define a taper configuration which the width or diameter of the second plug section 10G2′ tapers inwardly from the first plug portion 10G1′ to the bottom end 10B′. During operation, plug portion 10G′ is positioned inside of the drain opening 2A of the bathtub 2 as well as being positioned inside of and operably engaged with the drain strainer body 4C when the drain assembly removal tool 1′ cuts the drain strainer body 4C.

Guide plug 10′ may also define at least two widths along the head portion 10F′ and plug portion 10G′. As best seen in FIG. 9A, guide plug 10′ may define a first diameter or width “W1” that extends along the entire length of the head portion 10F′. Guide plug 10′ may define a second diameter or width “W2” that extends along the entire length of the plug portion 10G′ where the second diameter “W2” is less than the first diameter “W1” defined along the head portion 10F′. In other exemplary embodiments, guide plug 10′ may define any suitable diameters along the head portion 10F′ and the plug portion 10G′ dictated by the implementation of the guide plug 10′. When viewed in a plan view (as best seen in FIG. 8), the head portion 10F′ has a generally hexagonal configuration similar to the head portion 10F of guide plug 10 discussed above.

While not illustrated herein, guide plug 10′ may define at least one groove that extends radially around the exterior wall 10D′ and into the plug portion 10G′ substantially similar to the at least one groove 10H defined in guide plug 10 discussed above. Guide plug 10′ may also define at least one set of ridges that extend outwardly from the at least one groove at an intermediate surface of the guide plug 10′ similar to the first set of ridges 10J1 or the second set of ridges 10J2 provided with guide plug 10 discussed above.

While drain assembly removal tool 1′ includes the guide plug 10′ described and illustrated herein, it should be appreciated that guide plug 10′ may have suitable size, shape, and configuration to match with conventional or commercially-available drain strainer bodies. In one example, guide plug may have a smaller diameter than the first diameter “W1” and the second diameter “W2” of guide plug 10′ for smaller drain strainer bodies as compared to drain strainer body 4C referenced herein. In another example, guide plug may also have a larger diameter than the first diameter “W1” and the second diameter “W2” of guide plug 10′ for larger drain strainer bodies as compared to drain strainer body 4C referenced herein.

While drain assembly removal tool 1′ includes the guide plug 10′ described and illustrated herein, it should also be appreciated that drain assembly removal tool 1′ may include one or more guide plugs similar to guide plug 10′ with varying diameters and/or widths to match with conventional or commercially-available drain strainer bodies. In one example, drain assembly removal tool 1′ may include at least one guide plug that has a smaller diameter than the first diameter “W1” and the second diameter “W2” of guide plug 10′ for smaller drain strainer bodies as compared to drain strainer body 4C referenced herein. In another example, drain assembly removal tool 1′ may include at least another guide plug that has a larger diameter than the first diameter “W1” and the second diameter “W2” of guide plug 10′ for larger drain strainer bodies as compared to drain strainer body 4C referenced herein.

Drain assembly removal tool 1′ may also include at least one sealed bearing 20′ that operably engages with and is positioned inside of the guide plug 10′. As best seen in FIGS. 9A-9B, a first sealed bearing 20A′ is configured to engage with the head portion 10F′ inside of the passageway 10C′ proximate to the top end 10A′, particularly the interior wall 10E′ of the guide plug 10′. Still referring to FIGS. 9A-9B, a second sealed bearing 20B′ is configured to engage with the plug portion 10F′ inside of the passageway 10C′ proximate to the bottom end 10B′, particularly the interior wall 10E′ of the guide plug 10′. As described in greater detail below, the first sealed bearing 20A′ and the second sealed bearing 20B′ are configured to receive and engage with a blanked shank or arbor of a hole saw tool of the drain assembly removal tool 1′ to help rotationally guide the hole saw tool when the hole saw tool cut into the drain strainer body 4C of drain pipe system. Alternatively, a drill bit could be utilized instead of the blanked shank or arbor, however this may not be as desirable because the drill bill could damage the bearing.

It should be appreciated that drain assembly removal tool 1′ may use any commercially-available sealed bearings for first sealed bearing 20A′ and second sealed bearing that are configured to receive and engage with a blanked shank of a hole saw tool of the drain assembly removal tool 1′ to help rotationally guide the hole saw tool when the hole saw tool cut into the drain strainer body 4C of drain pipe system. Examples of suitable sealed bearings for drain assembly removal tool 1′ include sealed ball bearings, sealed thrust ball bearings, dry-running sleeve bearings, sealed roller bearings, and other suitable sealed bearings of the like. In the illustrated embodiment, the first sealed bearing 20A′ and the second sealed bearing 20B′ are conventional sealed ball bearings that engages with the guide plug 10′. It should also be appreciated that one or both of the first sealed bearing 20A′ and the second sealed bearing 20B′ may also be omitted from drain assembly removal tool 1′ if desired.

It should be appreciated that drain assembly removal tool 1′ may also include at least one gasket or O-ring that operably engages with the guide plug 10′ inside of at least one groove if defined in the guide plug 10′. In one instance, drain assembly removal tool 1′ may include a first gasket that operably engages with the guide plug 10′ inside of a first groove defined in guide plug 10′ (similar to first gasket 30A operably engaging with the guide plug 10 discussed above). In this instance, the first gasket may also operably engage with each ridge of a first set of ridges defined in the guide plug 10′ in which portions of the first gasket are positioned outside of the first groove to enable the first gasket to frictional fit with the drain strainer body 4C (see FIGS. 1 and 7A-7D). In another instance, drain assembly removal tool 1′ may include a second gasket that operably engages with the guide plug 10′ inside of a second groove defined in guide plug 10′ (similar to second gasket 30B operably engaging with the guide plug 10 discussed above). In this instance, the second gasket may also operably engage with each ridge of a second set of ridges defined in the guide plug 10′ in which portions of the second gasket are positioned outside of the second groove to enable the second gasket to frictional fit with the drain strainer body 4C (see FIGS. 1 and 7A-7D).

Drain assembly removal tool 1′ may also include a hole saw tool 40′ that operably engages with the guide plug 10′, via at least the sealed bearing 20′, and configured to encase the guide plug 10′ when cutting into the drain strainer body 4C, particularly the flange 4C1 of the drain strainer body 4C. Hole saw tool 40′ includes a hole saw blade 40A′, a blanked shank 40B′, and an attachment shank 40C′ that are substantially similar to the hole saw blade 40A, the blanked shank or auger 40B, and the attachment shank 40C of the hole saw tool 40 of drain assembly removal guide 1 discussed above. In this illustrated embodiment, however, the blanked shank 40B′ is configured to be received and housed inside of the first sealed bearing 20A′ and the second sealed bearing 20B′ to enable each of the first sealed bearing 20A′ and the second sealed bearing 20B′ to rotationally guide the hole saw tool 40′ as the hole saw blade 40A′ rotates and cuts into the flange 4C1 of the drain strainer body 4C. Stated differently, the blanked shank 40B′ couples with the first sealed bearing 20A′ and the second sealed bearing 20B′ to maintain a linear cutting direction of hole saw blade 40A′ while the hole saw tool 40′ freely rotates about the guide plug 10′ via rotational force applied by a power tool (e.g., a portable drill or similar power tool of the like).

While drain assembly removal tool 1′ includes hole saw tool 40′ described and illustrated herein, it should be appreciated that drain assembly removal tool 40′ may include one or more hole saw blades, similar to hole saw blade 40A′, with varying diameters and/or widths to match with conventional or commercially-available drain strainer bodies. In one example, drain assembly removal tool 1′ may include at least one hole saw blade that has a smaller diameter than the hole saw blade 40A′ described and illustrated herein for at least one guide plug that has a smaller diameter than the first diameter “W1” and the second diameter “W2” of guide plug 10′ for smaller drain strainer bodies as compared to drain strainer body 4C referenced herein. In another example, drain assembly removal tool 1′ may include at least another hole saw blade that has a larger diameter than hole saw blade 40A′ for at least one guide plug that has a larger diameter than the first diameter “W1” and the second diameter “W2” of guide plug 10′ and for larger drain strainer bodies as compared to drain strainer body 4C referenced herein.

Drain assembly removal tool 1′ may also include a retaining clip 50′ that operably engages with a terminal end of the blanked shank 40B′ longitudinally opposite to the attachment shank 40C′. As best seen in FIG. 9A, retaining clip 50′ is configured to be used as a stop or retainer for limiting the longitudinal movement of the blanked shaft 40B′ inside of the guide plug 10′. More particularly, the retaining clip 50′ is configured to be used as a stop or retainer for limiting the longitudinal movement of the blanked shaft 40B′ inside of the passageway 10C′ defined in guide plug 10′. In one example, the retaining clip 50′ may be a C-shaped retaining clip that limits the longitudinal movement of the blanked shaft 40B′ inside of the guide plug 10′. In another example, any suitable retaining clip may be used to limit the longitudinal movement of the blanked shaft 40B′ inside of the guide plug 10′.

Drain assembly removal tool 1′ may also include a biaser 60′ that operably engages with the guide plug 10′ and the hole saw tool 40′. As best seen in FIGS. 9A-9B, the biaser 60′ includes a top end 60A′ that operably engages with and inside of the hole saw blade 40A′, a bottom end 60B′ that operably engages with the top end 10A′ of the guide plug 10′ and longitudinally opposite to the top end 60A′, and a longitudinal axis defined therebetween. In the illustrated embodiment, the biaser 60′ is a compression-type spring that bias the guide plug 10′ and the hole saw tool 40′ away from one another (see FIG. 9A). In other exemplary embodiments, any suitable biaser may be used to bias the guide plug 10′ and the hole saw tool 40′ away from one another.

During operation, a plumber using the drain assembly removal tool 1′ may press downwardly on the hole saw tool 40′, via a portable drill or other tool for applying rotational force to the hole saw tool 40′, when the drain assembly removal tool 1′ is seated inside of the drain strainer body 4C. As best seen in FIGS. 9A-9B, the hole saw blade 40A′ may move linearly downward along the longitudinal axis of the guide plug 10′ to allow the hole saw blade 40A′ to cut into the flange 4C1 of the drain strainer body 4C. Upon this linear movement, the plumber must apply a suitable amount of pressure on the hole saw tool 40′ to overcome the biasing force applied to the guide plug 10′ and the hole saw tool 40′ by the biaser 60′. If such pressure is applied, the biaser 60′ compresses to enable the hole saw tool 40′ to move downwardly past the guide plug 10′ and into the drain strainer body 4C (see FIG. 9B). At this point, the biaser 60′ is provide in a compressed state.

Once the flange 4C1 and the threaded portion 4C2 of the drain strainer body 4C are cut and the plumber relieves the pressure from the hole saw tool 40′, the biaser 60′ may bias the hole saw tool 40′ longitudinally upward until the biaser 60′ is provided in the relaxed state (as seen in FIG. 9A). The retaining clip 50′ also reengages with the guide plug 10′ to prevent the terminal end of the blanked shank 40B′ from entering into the passageway 10C′ when the biaser 60′ is provided in the relaxed state.

During this cutting operation, the first sealed bearing 20A′ and the second sealed bearing 20B′ also provide rotational support and guidance to the blanked shank 40B′ as the hole saw tool 40′ cuts into the drain strainer body 4C. The first sealed bearing 20A′ and the second sealed bearing 20B′ also enable the blanked shank 40B′ to slideably move inside of the first sealed bearing 20A′ and the second sealed bearing 20B′ as the hole saw tool 40′ cuts downwardly into the drain strainer body 4C.

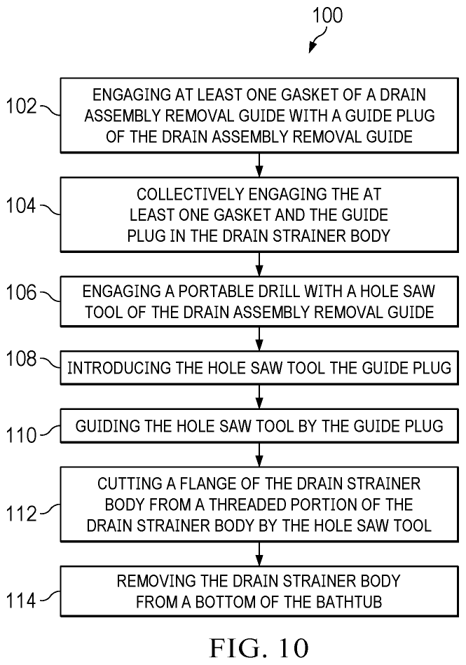

FIG. 10 illustrates a method 100 of removing a drain strainer body from a bathtub. An initial step 102 of method 100 includes engaging at least one gasket of a drain assembly removal guide with a guide plug of the drain assembly removal guide. Another step 104 of method 100 includes collectively engaging the at least one gasket and the guide plug in the drain strainer body. Another step 106 of method 100 includes engaging a portable drill with a hole saw tool of the drain assembly removal guide. Another step 108 of method 100 includes introducing the hole saw tool to the guide plug. Another step 110 of method 100 includes guiding the hole saw tool by the guide plug. Another step 112 of method 100 includes cutting the drain strainer body by the hole saw tool. Another step 114 of method 100 includes removing the drain strainer body from a bottom of the bathtub.

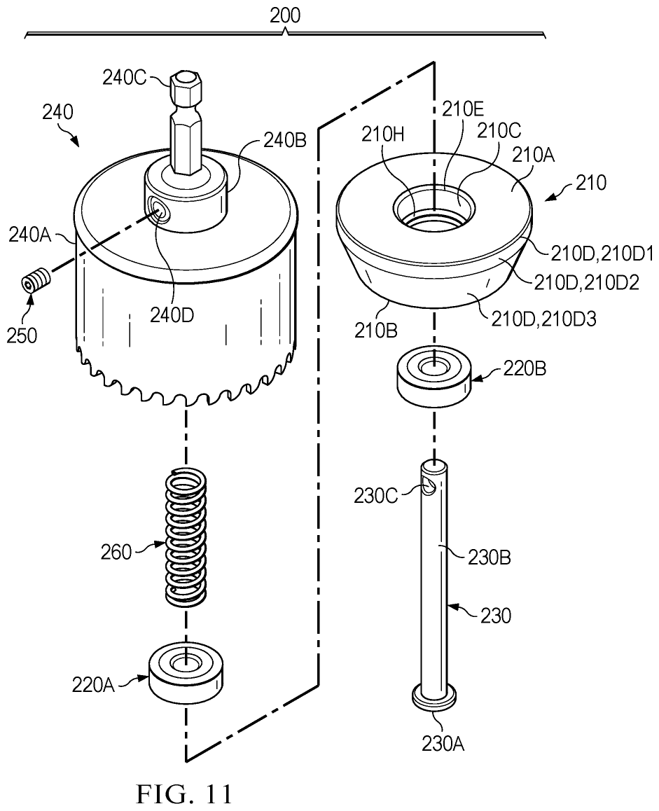

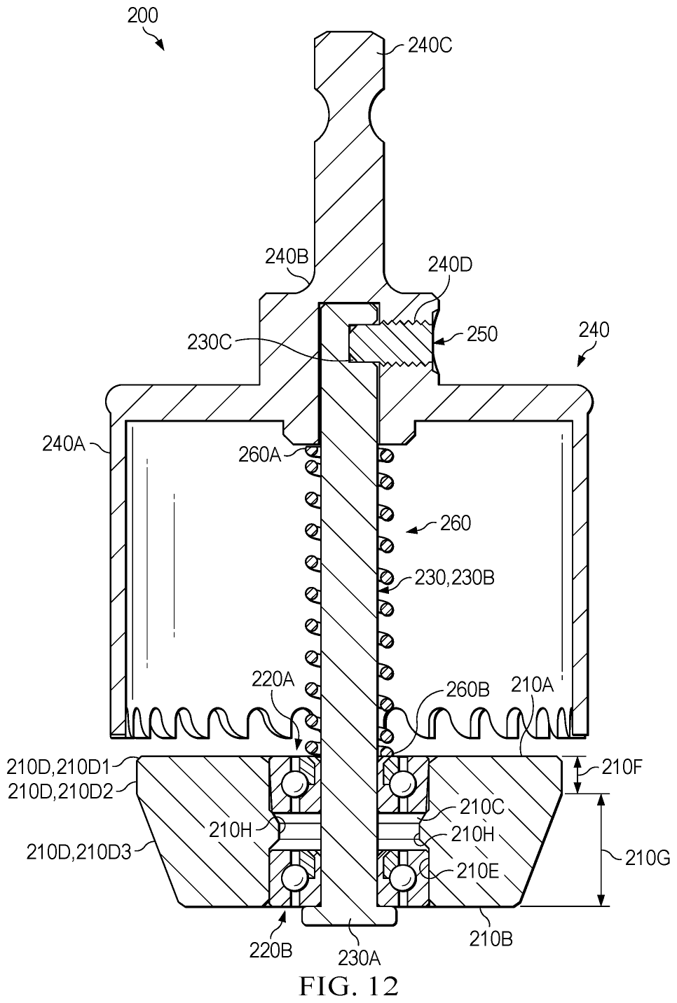

FIGS. 11-12 illustrate another drain assembly removal tool 200. Drain assembly removal tool 200 is substantially similar to drain assembly removal tools 1, 1′ described above and illustrated in FIGS. 1-9B, except as detailed below.

Drain assembly removal tool 200 includes a guide plug or guide bushing 210 that is adapted to operably engage with the drain strainer body 4C inside of the drain opening 2A defined in the bathtub 2. During a cutting operation, the guide plug 210 is adapted to operably engage with at least the threaded portion 4C2 of the drain strainer body 4C inside of the drain opening 2A defined in the bathtub 2. As best seen in FIGS. 11-12, guide plug 210 includes a top end 210A, a bottom end 210B vertically opposite to the top end 210A, and a longitudinal axis defined centrally therebetween. As best seen in FIG. 12, guide plug 210 also defines a passageway 210C that extends entirely through the guide plug 210 along the longitudinal axis of the guide plug 210 between the top end 210A and the bottom end 210B. Top end 210A and bottom end 210B are each substantially enclosed except for the portion of top end 210A that is open as defined by the passageway 210C and for the portion of bottom end 210B that is open as defined by the passageway 210C. Further, top end 210A and bottom end 210B are substantially flat when viewed in cross section. Due to the opening of passageway 210C, the top end 210A defines an upwardly facing flat annular surface and bottom end 210B defines a downwardly facing flat annular surface. The diameter of the annular surface defined by top end 210A may have a larger diameter, which is measured through the longitudinal axis, than the diameter of the annular surface defined by the bottom end 210B.

Guide plug 210 also includes an exterior wall 210D that extends around the perimeter of plug 210 along the entire length of the guide plug 210 from the top end 210A to the bottom end 210B. As best seen in FIGS. 11-12, guide plug 210 includes an upper exterior portion 210D1 that extends downwardly from the top end 210A to an intermediate exterior portion 210D2. The upper exterior portion 210D1 has a constant or uniform diameter. Guide plug 210 also includes a lower exterior portion 210D3 that extends and tapers downwardly from the intermediate exterior portion 210D2 to the bottom end 210B. Due to the tapered configuration of the lower exterior portion 210D3, the lower exterior portion 210D3 has a non-uniform diameter relative to the length of the lower exterior portion 210D3 between the intermediate portion 210D2 and the bottom end 210B. In one exemplary embodiment, the angle at which the lower exterior portion 210D3 tapers toward the longitudinal axis is less than about 45°. In one particular embodiment, the angle at which the lower exterior portion 210D3 tapers toward the longitudinal axis is in a range from about 10° to about 40°. In one example, there may be some criticality to this range or by having the tapering angle being less than about 45° to allow the lower end of the guide plug to extend a sufficient distance into the drain to ensure a proper fit of the guide plug during the cutting operation of the hole saw.

Guide plug 210 also includes an interior wall 210E that extends along the entire length of the guide plug 210, thereby defining passageway 210C, and is opposite to the exterior wall 210D (see FIG. 12). Guide plug 210 also includes an interior shoulder 210H that extends from the interior wall 210E and into the passageway 210C. The interior shoulder 210H is also defined between the top end 210A and the bottom end 210B and is positioned entirely inside of the passageway 210C. In this embodiment, the interior wall 210E is interrupted by the interior shoulder 210E extending into the passageway 210C.

Referring to FIG. 12, guide plug 210 also includes a head portion 210F that extends downwardly from the top end 210A to the intermediate exterior portion 210D2. As such, the head portion 210F is collectively defined by the upper exterior portion 210D1 and the intermediate exterior portion 210D2. During operation, head portion 210F may be positioned vertically above the drain opening 2A of the bathtub 2 as well as the drain strainer body 4C when the drain assembly removal tool 200 cuts the drain strainer body 4C. In one example, the intermediate exterior portion 210D2 may engage with the flange 4C1 yet the upper exterior portion 210D1 is positioned above the flange 4C1.

Guide plug 210 also includes a plug portion 210G that extends downwardly from the head portion 210F to the bottom end 210B. As best seen in FIG. 12, the plug portion 210G extends downwardly from the head portion 210F, particularly from the intermediate exterior portion 210D2, along the entire lower exterior portion 210D3 to the bottom end 210B. In the present disclosure, a diameter of the plug portion 210G tapers inwardly along the entire length of the lower exterior portion 210D3 from the intermediate exterior portion 210D2 to the bottom end 210B when viewed from a longitudinal cross-sectional view (see FIG. 12). During operation, plug portion 210G is positioned inside of the drain opening 2A of the bathtub 2 as well as being positioned inside of and operably engaged with the drain strainer body 4C when the drain assembly removal tool 200 cuts the drain strainer body 4C.

While not illustrated herein, guide plug 210 may define at least one groove that extends radially around the exterior wall 210D and into the plug portion 210G substantially similar to the at least one groove 10H defined in guide plug 10 discussed above. Guide plug 210 may also define at least one set of ridges that extend outwardly from the at least one groove at an intermediate surface of the guide plug 210 similar to the first set of ridges 10J1 or the second set of ridges 10J2 provided with guide plug 10 discussed above. If included, a gasket or O-ring may be received by the at least one groove and the at least one set of ridges such that the gasket or O-ring extends beyond the exterior wall 210D of the guide plug 210 to engage with a drain strainer body. Further, the head portion 210F does not need to be circular, the head portion may be any other shape. For example, instead of the head portion 210F having a circular perimeter, the perimeter of the head portion can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Drain assembly removal tool 200 may also include at least one sealed bearing 220 that operably engages with and is positioned inside of the guide plug 210. As best seen in FIGS. 11-12, a first sealed bearing 220A operably engages with the head portion 210F inside of the passageway 210C proximate to the top end 210A. Particularly, the first sealed bearing 220A operably engages with the interior wall 210E and interior shoulder 210H of the guide plug 210 and is positioned between the top end 210A and the interior shoulder 210H. Still referring to FIGS. 11-12, a second sealed bearing 220B operably engages with the plug portion 210F inside of the passageway 210C proximate to the bottom end 210B. Particularly, the second sealed bearing 220B operably engages with the interior wall 210E and the interior shoulder 210H and is positioned between the bottom end 210B and the interior shoulder 210H.

As described in greater detail below, the first sealed bearing 220A and the second sealed bearing 220B are configured to receive and engage with an arbor or pin of the drain assembly removal tool 210 to help rotationally guide a cutting tool when the cutting tool cuts into the drain strainer body 4C of drain pipe system. Alternatively, a drill bit could be utilized instead of the pin, however this may not be as desirable because the drill bill could damage one or both bearings 220A, 220B.

It should be appreciated that drain assembly removal tool 200 may use any commercially-available sealed bearings for first sealed bearing 220A and second sealed bearing 220B that are configured to receive and engage with an arbor or pin of the drain assembly removal tool 210 to help rotationally guide a cutting tool when the cutting tool cuts into the drain strainer body 4C of drain pipe system. Examples of suitable sealed bearings for drain assembly removal tool 200 include sealed ball bearings, sealed thrust ball bearings, dry-running sleeve bearings, sealed roller bearings, and other suitable sealed bearings of the like. In the illustrated embodiment, the first sealed bearing 220A and the second sealed bearing 220B are conventional sealed ball bearings that engages with the guide plug 210. It should also be appreciated that one or both of the first sealed bearing 220A and the second sealed bearing 220B may also be omitted from drain assembly removal tool 200 if desired.

Drain assembly removal tool 200 may also include a pin or shank 230 that is operably engageable with the guide plug 210. As best seen in FIG. 10, the pin 230 includes a head 230A, a shaft 230B that extends outwardly from the head 230A, and an attachment cavity 230C defined in the shaft 230B. In the present disclosure, the attachment cavity 230C extends into the shaft 320C along an axis that is orthogonal to a longitudinal axis of the pin 230. The attachment cavity 230C is also defined at a distance away from the head 230A such that the head 230A and attachment cavity 230C are remote from one another.

Upon assembly, the head 230A of the pin 230 directly engages with the guide plug 210 at the bottom end 210B. As best seen in FIG. 12, the head 230A defines a diameter that is greater than a diameter of the passageway 210C of the guide plug 210 so that the guide plug 210 is prevented from sliding off of the pin 230. A portion of the shaft 230B is also housed inside of the passageway 210C and operably engages with both of the first sealed bearing 220A and the second sealed bearing 220B. Upon such configuration, the first sealed bearing 220A and the second sealed bearing 220B provide axial support to the shaft 230B during cutting operations of the drain assembly removal tool 200. A terminal end of the shaft 230B, which is opposite to and remote from the head 230A, engages with a coupler of a hole saw tool of the drain assembly removal tool 200 to link the guide plug 210 and the hole saw tool with one another; such features of the hole saw tool are discussed in greater detail below.

Drain assembly removal tool 200 may also include a cutting tool or hole saw tool 240 that operably engages with the guide plug 210, via the pin 230, and is configured to encase the guide plug 210 when cutting into the drain strainer body 4C, particularly the flange 4C1 of the drain strainer body 4C.

As best seen in FIGS. 11-12, hole saw tool 240 includes a hole saw blade 240A that is similar to the hole saw blade 40 mentioned above. Hole saw tool 240 also includes a coupler 240B that operably engages with and extends outwardly from the hole saw blade 240A. In one exemplary embodiment, hole saw blade 240A and coupler 240B may be integral with one another to form a unitary or single body. In another exemplary embodiment, hole saw blade 240A and coupler 240B may be separate from one another to form a two-piece component. Hole saw tool 210 may also include an attachment shank 240C that is substantially similar to attachment shank 40C of hole saw tool 40. As such, attachment shank 240C enables a power tool, such as an electric drill, (separate from the drain assembly removal tool 1) to engage with the hole saw tool 240 and to automatically rotate the hole saw blade 240A for cutting into the drain strainer body 4C.

Still referring to hole saw tool 240, hole saw tool 240 also defines a threaded passageway 240D. Particularly, and as best seen in FIGS. 11-12, the threaded passageway 240D is defined in the coupler 240B. It should be understood that the threaded passageway 240D extends entirely through the coupler 240B to allow an interior space defined inside of the coupler 240B and the external environment surrounding the coupler 240B to be in operative communication with one another. Such use and purpose of the threaded passageway 240D is discussed in greater detail below.

Drain assembly removal tool 200 also includes a connector 250 that operably engages the pin 230 with the hole saw tool 240. As best seen in FIG. 12, the connector 250 is threadably engageable with the coupler 240B at the threaded passageway 240D. A portion of the connector 250 also operably engages with the pin 230, particularly with the shaft 230B inside of the attachment cavity 230C, to engage the pin 230 and the hole saw tool 240 with one another. Upon assembly, the connector 250 may be substantially housed inside of the coupler 240B once the connector 250 engages with the pin 230. In other exemplary embodiments, a connector discussed herein may also engage with a shaft of a pin discussed herein wherein the shaft is free from defining any cavity or similar void to which the connector directly engages with an outer wall of the shaft to pin or lock the shaft inside of a hole saw tool mentioned herein.

Drain assembly removal tool 200 may also include a biaser 260 that operably engages with the guide plug 210 and the hole saw tool 240. As best seen in FIG. 12, the biaser 260 includes a top end 260A that operably engages with and is positioned inside of the hole saw blade 240A, a bottom end 260B that operably engages with the top end 210A of the guide plug 10 and longitudinally opposite to the top end 260A, and a longitudinal axis defined therebetween. Upon assembly, the biaser 260 is also positioned about a portion of the pin 230 to maintain the vertical position of the biaser 260 as the biaser 260 moves along the pin 230. In the illustrated embodiment, the biaser 260 is a compression-type spring that bias the guide plug 210 and the hole saw tool 240 away from one another (see FIG. 12). In other exemplary embodiments, any suitable biaser may be used to bias the guide plug 210 and the hole saw tool 240 away from one another.

Similar to the operations mentioned above, a plumber using the drain assembly removal tool 200 may press downwardly on the hole saw tool 200, via a portable drill or other tool for applying rotational force to the hole saw tool 240, when the drain assembly removal tool 200 is seated inside of the drain strainer body 4C. In this embodiment, the hole saw blade 240A may move linearly downward along the longitudinal axis of the guide plug 210 to allow the hole saw blade 240A to cut into the flange 4C1 of the drain strainer body 4C as the hole saw is rotatably driven by the electric drill. Upon this linear movement, the plumber must apply a suitable amount of downward pressure on the hole saw tool 240 to overcome the biasing force applied to the guide plug 210 and the hole saw tool 240 by the biaser 260. If such pressure is applied, the biaser 260 compresses from an extended or first position (see FIG. 12) to a compressed or second position to move the hole saw tool 240 downwardly past the guide plug 210 and into the drain strainer body 4C. At this point, the biaser 260 is provide in a compressed state. Once the hole saw blade 240A has performed the cutting operation (as mentioned above and as seen in FIGS. 7C-7D) and the force initially applied by the plumber is removed, the biaser 260 presses the guide plug 210 and the hole saw tool 240 away from one another back to the extended position.

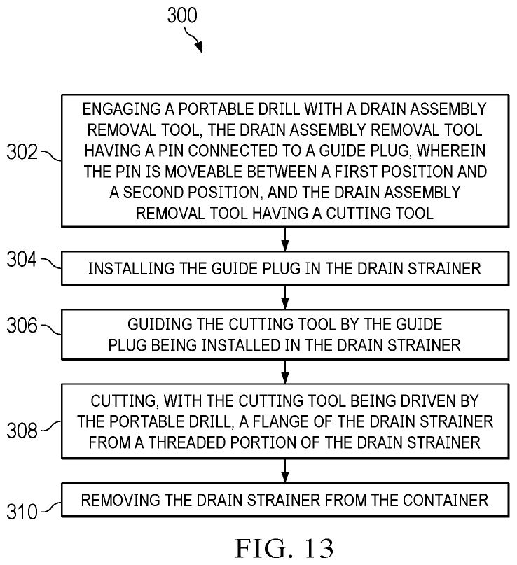

FIG. 13 is a method 300 of removing a drain strainer from a container. An initial step 302 of method 300 includes engaging a portable drill with a drain assembly removal tool, the drain assembly removal tool having a pin connected to a guide plug, wherein the pin is moveable between a first position and a second position, and the drain assembly removal tool having a cutting tool. Another step 304 of method 300 includes installing the guide plug in the drain strainer. Another step 306 of method 300 includes guiding the cutting tool by the guide plug being installed in the drain strainer. Another step 308 of method 300 includes cutting, with the cutting tool being driven by the portable drill, a flange of the drain strainer from a threaded portion of the drain strainer. Another step 310 of method 300 includes removing the drain strainer from the container.

In other exemplary embodiments, method 300 may include optional and/or additional steps for removing a drain strainer from a container. In one exemplary embodiment, method 300 may further include a step of supporting the pin, by at least one sealed bearing of the drain assembly removal tool, along a rotational axis of the pin. In another exemplary embodiment, method 300 may further include a step of applying a biasing force to the guide plug, by a biaser of the drain assembly removal tool, that maintains the guide plug at the first position; wherein a portion of the guide plug is positioned external to the cutting tool. In another exemplary embodiment, method 300 may further include steps of applying an external force on the guide plug and the cutting tool, wherein the external force is greater than the biasing force of the guide plug; and moving the guide plug along the pin from the first position to the second position; wherein the cutting tool completely surrounds the guide plug in the second position. In another exemplary embodiment, method 300 may further include a step of engaging the at least one sealed bearing inside a passageway defined by the guide plug between a first end of the guide plug and a shoulder positioned inside of the passageway. In another exemplary embodiment, method 300 may further include steps of engaging at least another sealed bearing inside of the passageway between a second end of the guide plug that is opposite to the first end and the shoulder; and supporting the pin, by at least another sealed bearing of the drain assembly removal guide, along the rotational axis of the pin. In another exemplary embodiment, method 300 may further include steps of engaging at least one gasket of the drain assembly removal tool with the guide plug of the drain assembly removal tool; and engaging the at least one gasket inside of the drain strainer.

It should be understood that while drain assembly removal tools 1, 1′, 200 may be used to remove a drain strainer body from a bathtub, the drain assembly removal tools 1, 1′, 200 may also be used to remove similar drain strainer bodies or similar drain components from containers or basins if desired. As such, references to bathtub herein should not limit or restrict the use of drain assembly removal tools 1, 1′, 200 for removing similar drain strainer bodies or similar drain components from containers or basins if desired.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A drain assembly removal tool, comprising:
a guide plug adapted to engaged with and be seated at least partially inside of a drain strainer;
a pin operably engaged with the guide plug; and
a cutting tool operably engaged with the pin and adapted to cut into a flange of the drain strainer body;
wherein the pin is moveable between a first position and a second position relative to the guide plug when the guide plug is seated at least partially inside the drain strainer.

2. The drain assembly removal tool of claim 1, further comprising:
at least one sealed bearing operably engaged with and inside of the guide plug and operably engaged with the pin.

3. The drain assembly removal tool of claim 1, further comprising:
a biaser operably engaged with the guide plug and the pin;
wherein the biaser is configured to apply a biasing force on the guide plug and the cutting tool.

4. The drain assembly removal tool of claim 3, wherein the biaser comprises:
a first end that operably engages with the cutting tool; and
a second end opposite to the first end and the second end operably engages the guide plug.

5. The drain assembly removal tool of claim 1, wherein the pin comprises:
a head that operably engages with the guide plug; and
a shaft extending from the head and the shaft operably engages the cutting tool.

6. The drain assembly removal tool of claim 5, further comprising:
a connector operably engaging the shaft of the pin with the cutting tool;
wherein the pin is removably engaged with the cutting tool.

7. The drain assembly removal tool of claim 6, wherein the pin further comprises:
an attachment cavity defined in the shaft of the pin;
wherein the connector operably engages with the pin inside of the attachment cavity.

8. The drain assembly removal tool of claim 2, wherein the guide plug comprises:
a top end;
a bottom end opposite to the top end;
a passageway defined between the top end and the bottom end;
wherein the at least one sealed bearing is positioned within the guide plug inside of the passageway.

9. The drain assembly removal tool of claim 8, wherein the guide plug further comprises:
a shoulder extending into the passageway and positioned at a location between the top end and the bottom end;
wherein the at least one sealed bearing is adjacent the shoulder and is positioned between the top end and the shoulder.

10. The drain assembly removal tool of claim 9, further comprising:
at least another sealed bearing operably engaged with and inside of the guide plug and operably engaged with the pin;
wherein the at least another sealed bearing operably engages with the shoulder and is positioned between the bottom end and the shoulder.

11. The drain assembly removal tool of claim 1, further comprising:
at least one gasket operably engaged with the guide plug;
wherein the at least one gasket is configured to extend beyond an plug portion of the guide plug.

12. The drain assembly removal tool of claim 11, wherein the guide plug further comprises:
a top end;
a bottom end opposite to the top end; and
a groove defined in the guide plug between the top end and the bottom end;
wherein the at least one gasket is configured to be received by the groove.

13. The drain assembly removal tool of claim 1, wherein the guide plug further comprises:
a head portion; and
a plug portion extending from the head portion;
wherein at least the plug portion is adapted to be engaged with and be positioned inside of the drain strainer.

14. A method of removing a drain strainer from a container, the method comprising:
engaging a portable drill with a drain assembly removal tool, the drain assembly removal tool having a pin connected to a guide plug, wherein the pin is moveable between a first position and a second position, and the drain assembly removal tool having a cutting tool;
installing the guide plug in the drain strainer;
guiding the cutting tool by the guide plug being installed in the drain strainer;
cutting, with the cutting tool being driven by the portable drill, a flange of the drain strainer from a threaded portion of the drain strainer; and
removing the drain strainer from the container.

15. The method of claim 14, further comprising:
supporting the pin, by at least one sealed bearing of the drain assembly removal tool, along a rotational axis of the pin.

16. The method of claim 14, further comprising:
applying a biasing force to the guide plug, by a biaser of the drain assembly removal tool, that maintains the guide plug at the first position;
wherein a portion of the guide plug is positioned external to the cutting tool.

17. The method of claim 16, further comprising:
applying an external force on the guide plug and the cutting tool, wherein the external force is greater than the biasing force of the guide plug; and
moving the guide plug along the pin from the first position to the second position;
wherein the cutting tool completely surrounds the guide plug in the second position.

18. The method of claim 15, further comprising:
engaging the at least one sealed bearing inside a passageway defined by the guide plug between a first end of the guide plug and a shoulder positioned inside of the passageway.

19. The method of claim 18, further comprising:
engaging at least another sealed bearing inside of the passageway between a second end of the guide plug that is opposite to the first end and the shoulder; and
supporting the pin, by at least another sealed bearing of the drain assembly removal guide, along the rotational axis of the pin.

20. The method of claim 14, further comprising:
engaging at least one gasket of the drain assembly removal tool with the guide plug of the drain assembly removal tool; and
engaging the at least one gasket inside of the drain strainer.
